(19) United States
(12) Patent Application Publication
(10) Pub. No.: US 2002/0184963 A1
(43) Pub. Date: Dec. 12, 2002

(54) Controlled release parking brake system

(76) Inventors: Larry Brian Champ, Cairo, MO (US); Steve William Marek, Moberly, MO (US)

Correspondence Address: MICHAEL K. BOYER, ORSCHELN MANAGEMENT CO, 2000 US HWY 63 SOUTH, MOBERLY, MO, 65270, US

(21) Appl. No.: 10/160,209

(22) Filed: May 30, 2002

Related U.S. Application Data
(60) Provisional application No. 60/297,061, filed on Jun. 8, 2001.

(51) Int. Cl. G05G 1/14

(52) U.S. Cl. 74/560

(57) ABSTRACT

A controlled release parking brake system is disclosed that comprises a parking brake lever (either foot or hand operated), a dampening system, at least one cable and a connection to a conventional braking system operated by the cable. The disclosed assembly can be employed to control the release of a parking brake on a wide range of vehicles such as passenger cars, all terrain vehicles, lawn equipment and tractors, trucks (e.g., Class 5-7), utility cars, among other applications wherein it is desirable to have controlled release of mechanical energy or force.

The subject matter herein claims benefit under 35 U.S.C. 119(e) of U.S. Patent Application Serial No. 60/297,061, filed on Jun. 8, 2001, and entitled “Controlled Release Parking Brake System”; the disclosure of which is hereby incorporated by reference.

### FIELD OF THE INVENTION

The instant invention relates to a controlled release parking brake system comprising a parking brake lever (either foot or hand operated), a dampening system, at least one cable and a connection to a conventional braking system operated by the cable. The assembly can be employed to control the release of a parking brake on a wide range of vehicles such as passenger cars, all terrain vehicles, lawn equipment and tractors, trucks (e.g., Class 5-7), utility cars, among other applications wherein it is desirable to have controlled release of mechanical energy or force.

### BACKGROUND OF THE INVENTION

Conventional parking brake assemblies are either hand or foot actuated and are used by an operator to tension a cable and in turn operate a parking brake. In the case of a foot operated assembly one end of a parking brake lever includes a foot pedal whereas in a hand operated assembly one end of the parking brake lever will typically include a release button. Examples of hand or foot operated parking brake systems are described in U.S. Pat. Nos. 5,309,786; 5,462,146; 5,875,689; and 5,75,688; hereby incorporated by reference.

When a conventional parking brake assembly is applied, the parking brake lever is displaced to an engaged position. When conventional parking brake assemblies are disengaged, the energy of the system is released thereby permitting a parking brake lever to travel to a disengaged position. In some cases if the parking brake is disengaged or released in an uncontrolled manner, components of the parking brake assembly such as the parking brake lever as well as adjoining systems (e.g., instrument panel), may be damaged (e.g, caused when the parking brake lever impacts its released position). The degree of any damage can be increased when a vehicle operator applies additional force when releasing the parking brake (known as “slam off”).

There is a need in this art for a parking brake assembly wherein the parking brake is released in a controlled fashion that minimizes damage to components of the parking brake assembly (e.g., parking brake lever). There is also a need in this art for an improved parking brake system having reduced wear (or increased operational life).

### SUMMARY OF THE INVENTION

The instant invention solves problems associated with convention parking brake systems by providing a dampening system. The dampening system comprises a fluid dampener (e.g,. a rod and a hollow cylinder wherein one end of the cylinder is open and the other is closed). The fluid can comprise gas (e.g., air) or liquid (e.g., hydraulic oil). In the case of a gas or pneumatic dampener, the rod is received within the open end of the cylinder, and moves within and along the longitudinal axis of the cylinder.

The dampening system is located within the parking brake system in a manner sufficient to control the release of the parking brake lever into a disengaged or released position. While the dampening system controls the rate at which the parking brake lever travels to its released position, the dampening system does not inhibit parking brake application, or complete disengagement or release of the parking brake assembly.

### BRIEF DESCRIPTION OF THE DRAWINGS

FIGS. 1A-1C illustrate one aspect of the instant invention wherein the parking brake assembly is in an applied or engaged position.

FIGS. 2A-2C illustrate the aspect of the invention shown in FIGS. 2A-2C in a released or disengaged position.

FIGS. 3A-3C illustrate another aspect of the instant invention wherein the dampening system comprises a rod defining at least one channel.

FIGS. 4A-4C illustrate a cylinder that can be employed along with the rod illustrated in FIGS. 3A-3C.

FIGS. 5A-5C illustrate the cylinder and rod of FIGS. 3A-4C as assembled.

FIGS. 6A-6C illustrate a further aspect of the instant invention wherein the dampening system comprises a cylinder defining at least one channel for mounting an o-ring.

FIGS. 7A-7B′ illustrate a rod that can be employed with the cylinder illustrated in FIGS. 6A-6C.

FIGS. 8A-8C′ illustrate the cylinder and rod of FIGS. 6A-6C as assembled.

Dimensions shown in these Figures are for illustration purposes only and do not limit the scope of the appended claims, or the size or relative dimensions of an apparatus embodying the invention.

### DETAILED DESCRIPTION

The instant invention relates to a controlled release parking brake system comprising a parking brake lever (either foot or hand operated), and a dampening system. The parking brake system can further comprise at least one cable and a connection to a conventional braking system operated by the cable. The dampening system can be employed on any suitable conventional hand or foot operated parking brake system.

Any suitable dampening system can be employed that provides controlled release of the parking brake system. An example of a suitable dampening system comprises a sealed gas-oil filled member supplied commercially by ACE Gas Springs, Farmington, Michigan. Another example of a suitable dampening system comprises an oil containing member (e.g., supplied by Suspa Inc., Grand Rapids, Michigan).

In one aspect of the invention, the oil containing member comprises a hydraulic apparatus comprising a pressure pipe, a piston rod and a dampening oil medium. The piston rod travels within the dampening oil containing pressure pipe. The piston rod defines an opening or a bore through which the dampening oil passes as the piston rod travels within the pressure pipe. The dampening system that is employed in the inventive system has a desired orifice opening within the piston, suitable mounting members for attachment to the parking brake lever and mounting bracket(s), contains oil having a predetermined viscosity and amount, among other parameters conventionally associated with dampening systems. Typically, the hydraulic apparatus is sealed from the surrounding environment.

In another aspect of the invention, the dampening system comprises a rod and a hollow cylinder wherein one end of the cylinder is open and the other is closed. One end of the rod is received within the open end of the cylinder, and moves within and along the longitudinal axis of the cylinder. The orientation of the rod and cylinder is selected so as to minimize any affects associated with exposure to the surrounding environment (e.g., liquids). The dampening system can be attached to the parking brake system by connections to the closed end of the cylinder and the end of the rod not received within the cylinder.

In another aspect of the invention, the dampening system employs a rod defining at least two openings connected by a channel. The two openings correspond to two regions within the cylinder. The openings allow air to flow between the two regions defined within the cylinder. The two regions are separated or sealed by an O-ring mounted about the rod. Displacement or movement of the rod is controlled by the rate at which air passes through the channel. When the parking brake system is engaged, air is drawn into and fills the region within the cylinder defined by O-ring, rod end and the cylinder's closed end. When the parking brake system is disengaged, the rate at which the rod is permitted to travel into the region is determined by the rate at which air exits the region (e.g., from outside of the dampening system along the clearance between the rod and the cylinder through the channel). The travel rate of the rod in turn controls the rate with which the parking brake lever moves toward its disengaged position.

In a further aspect of the invention, the dampening system employs a rod and a cylinder wherein an O-ring is located adjacent to the open end of the cylinder. The O-ring is located within the interior portion of the cylinder and contacts the exterior surface of the rod. The rod defines at least two grooves for controlling passage of air into the dampening system. The grooves can be defined as channels running perpendicular to the longitudinal axis of the rod (and cylinder).

The dampening system is located within the parking brake system in a manner sufficient to control the release of the parking brake lever into a disengaged or released position. The dampening system can be connected to the parking brake system by any suitable manner such as pins, slots, rivets, among other fasteners known in the art.

In an aspect of the invention, the dampening system is pivotally connected to the parking brake lever of the parking brake system and a mounting bracket. The parking brake lever can be pivotally connected to a handle (for a hand operated systems) or a foot pedal lever (for foot operated systems). The handle is also pivotally connected to the mounting bracket. The distance which the parking brake lever is displaced is defined by movement of a pin within a slot defined within the mounting bracket. The end of the parking brake lever associated with the pin also defines an attachment point for a cable that operates a parking brake (e.g., a clevis for receiving the cable is attached to the parking brake lever adjacent to the pin).

While the dampening system controls the rate at which the parking brake lever travels to its released position, the dampening system does not inhibit parking brake application, or complete disengagement or release of the parking brake assembly. The rate at which the parking brake lever travels to its released position is dependent upon the rate at which fluid (e.g., hydraulic oil) travels through the dampening system. In the case of a dampening system employ air, the travel rate or velocity is dependent upon the rate at which air enters the dampening system (e.g., approximately 3 to 6 seconds).

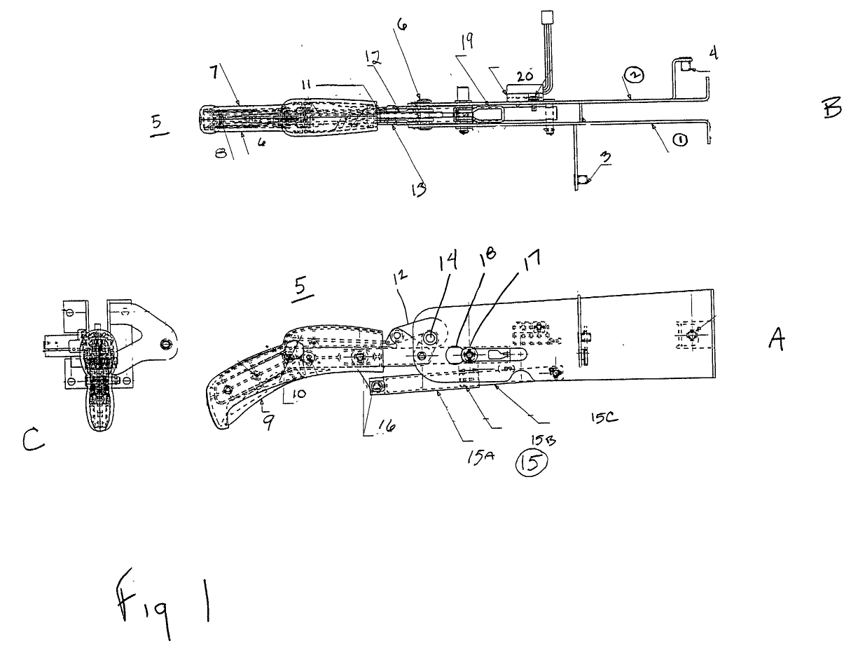

Certain aspects of the invention are better understood by reference to the drawings. Referring now to FIG. 1, FIG. 1 illustrates an aspect of the invention comprising a hand operated parking brake system, which comprises a handle, parking lever, damping system and mounting bracket, in an engaged position. While the illustrated parking brake system is intended to be mounted upon the floor of a vehicle, the parking brake system can be mounted at any convenient location (e.g., floor, under dash, upon dash, among other locations). One end of the parking brake lever is attached to the dampening system and the other end is pivotally connected to a pin that slides within a slot defined on the mounting bracket. The engaged position applies a tensile force upon a cable and in turn operates a parking brake. When in the engaged position, the dampening system is fully extended (or the rod as traveled its maximum distance outside of the cylinder). The parking brake system is maintained in an engaged position by a pivotally mounted hook that engages a rivet or pin that is affixed to the mounting bracket. The hook is operated by movement of a release lever on the handle.

FIGS. 1A through 1C illustrate mounting bracket having sides 1 and 2. Mounting bracket is maintained a predetermined location within the vehicle by fasteners (not shown) inserted through mounting points 3 and 4. Handle system 5 is pivotally mounted between mounting bracket sides 1 and 2 via rivet 6. Handle system 5 comprises hand grip 6 that is affixed into position by a fastener 7 and rivet 8. Handle system 5 is pivoted by depressing release handle 9 which in turn compresses spring 10 (which biases release handle 9 into an un-depressed position). Operation of release handle 9 activates release rod that causes hook 12 to pivot outwardly about rivet 13 and disengage pin 14 thereby permitting handle system 5 to pivot about rivet 6. Pivotal movement of handle system 5 causes operation of dampening system 15 (comprising dampener body or cylinder 15A, sealing O-ring 15B and rod or piston 15C.) Dampening system 15 is functionally connected to handle system 5 via link pin 16. Dampening system 15 is functionally connected to mounting bracket sides 1 and 2 via link pin or roller 17 that is slideably retained in slot 18 defined in mounting bracket sides 1 and 2. Clevis 19 connects movement of the handle system 5 to a cable system (not shown). The movement of the cable system in turn operates a braking system (e.g., drive line, wheel-drum, among others). The position (engaged or disengaged) sensor 20 provides a signal that indicates to the vehicle operator whether the parking brake system has been activated.

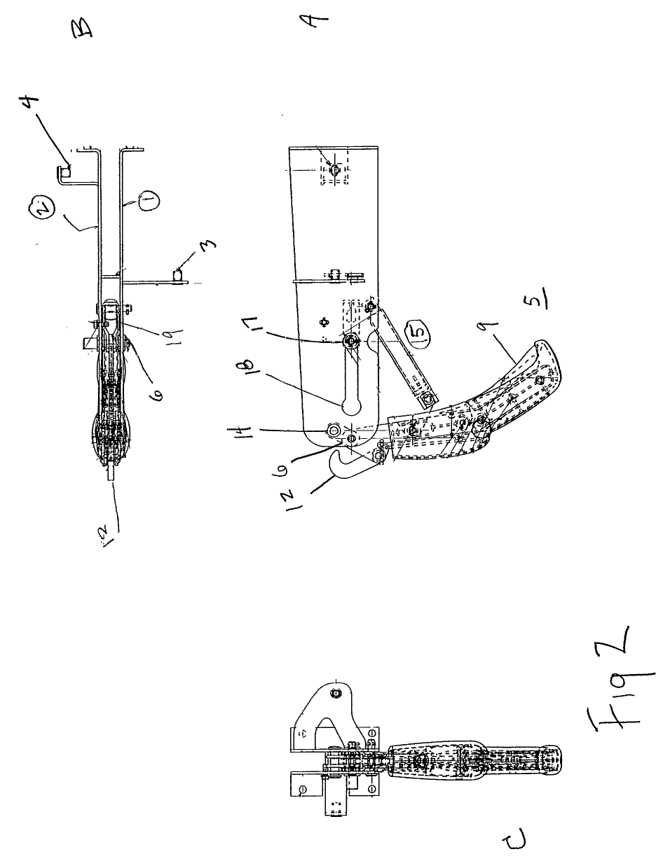

Referring now to FIG. 2, FIG. 2 illustrates the parking brake system of FIG. 1 in a disengaged position. The hook has been released which allows the tension in the cable to draw the parking brake lever into a disengaged position. The release (or rate at which the handle/parking brake lever pivot about the mounting bracket) is controlled by the dampening system. The pin on the parking brake lever has traveled its maximum distance (away from the hook engaging rivet and towards the dampening system connection point on the mounting bracket) within the slot. When in the disengaged position, the dampening system is compressed (or the rod as traveled its maximum distance into the cylinder). The parking brake system remains in the disengaged position until the vehicle operator pulls on the handle and pivotally displaced the handle sufficient to allow the hook to engage the rivet.

FIGS. 2A through 2C illustrate the parking brake system of FIG. 1 in a disengaged position wherein release handle 9 has been depressed and hook 12 released thereby permitting dampening system 15 to compress (e.g, piston 15A traveling within cylinder 15C). The rate at which dampening system 15 is compressed determines the rate at which clevis 19 releases the tension on the cable and in turn braking system, and velocity at which handle system 5 travels toward the mounting brackets 1 and 2

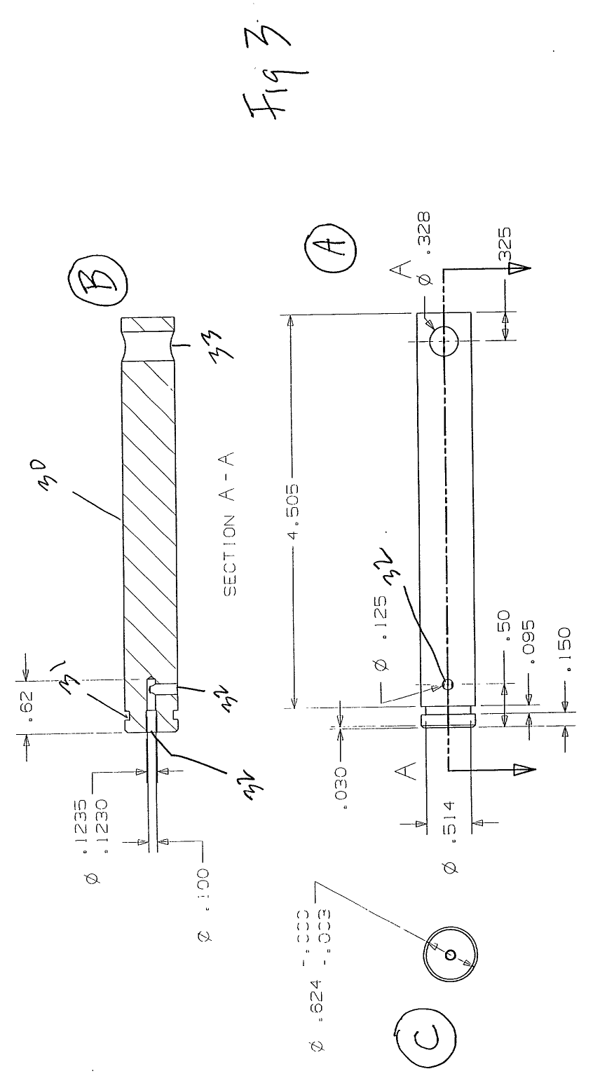

FIGS. 3A through 8 illustrate two aspects of the dampening system. FIGS. 3 through 7 illustrate one aspect of the dampening system wherein the rod defines at least one channel and a groove for retaining an O-ring. The end of rod distal from the O-ring defines an opening for connection to the parking brake lever or mounting bracket (e.g,. via pin, rivet or other pivotal connection). The connection point is selected so as to minimize affects caused by exposure to the surrounding environment (e.g., connecting the rod to the mounting bracket with the other end traveling within the cylinder). The openings of the channel can be defined by an inserted member (e.g., a hollow set screw having an orifice). The connection point of the cylinder varies depending upon the connection point of the rod (e.g., mounting bracket or parking brake lever). When the rod is connected to the mounting bracket, the cylinder is connected to the parking brake lever (e.g., via pin, rivet or other pivotal connection).

Referring now to FIGS. 3A through C, these Figures illustrate the piston or rod that can be employed in a dampening system (e.g., a pneumatic system). FIG. 3 illustrates piston 30 having a channel 31 for receiving an O-ring (or other suitable sealing system), and orifice 32. Piston 30 also defines an opening 33 for receiving a fastener in order to connect the piston component of the dampening system to, for example, a mounting bracket (e.g., refer to brackets 1 and 2 of FIGS. 1 and 2). The dimensions of orifice 32 determine the rate at which air can enter or exit the illustrated dampening system.

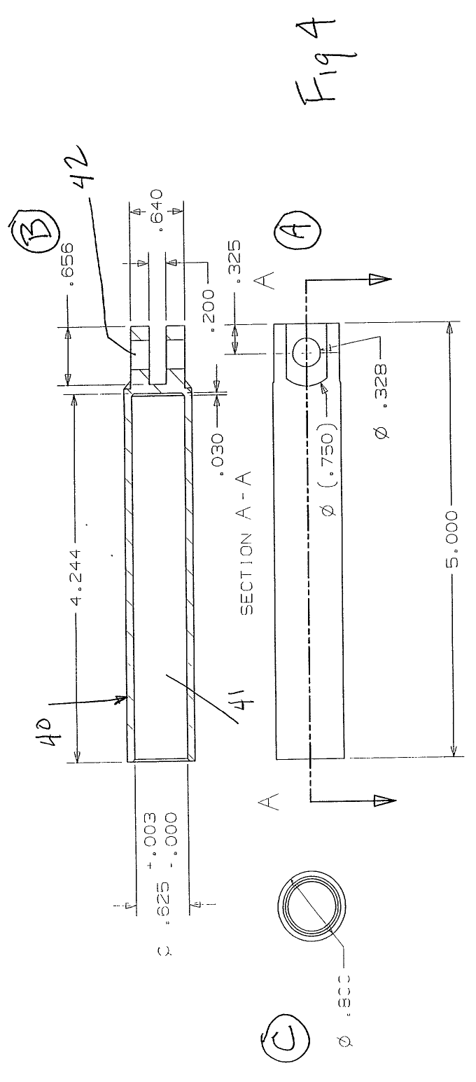

Referring now to FIGS. 4A through 4C, FIGS. 4A through 4C illustrate a cylinder or tube component 40 of the dampening system that is dimension to receive piston 30 illustrated in FIG. 3. Cylinder 40 defines a bore or channel 41 and an opening 42. Opening 42 is employed for receiving a fastener in order to connect the cylinder to a parking brake handle system (e.g., handle system 5 illustrated in FIGS. 1 and 2).

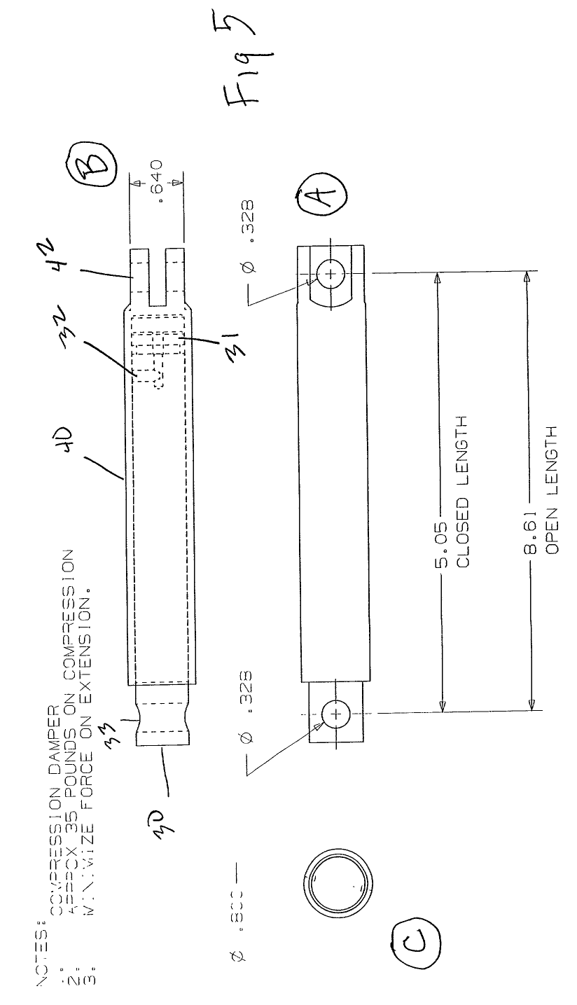

Referring now to FIGS. 5A through 5C, FIGS. 5A through 5C illustrate the piston and cylinder of FIGS. 3 and 4 in a compressed position or wherein the piston has traveled the maximum distance within the cylinder.

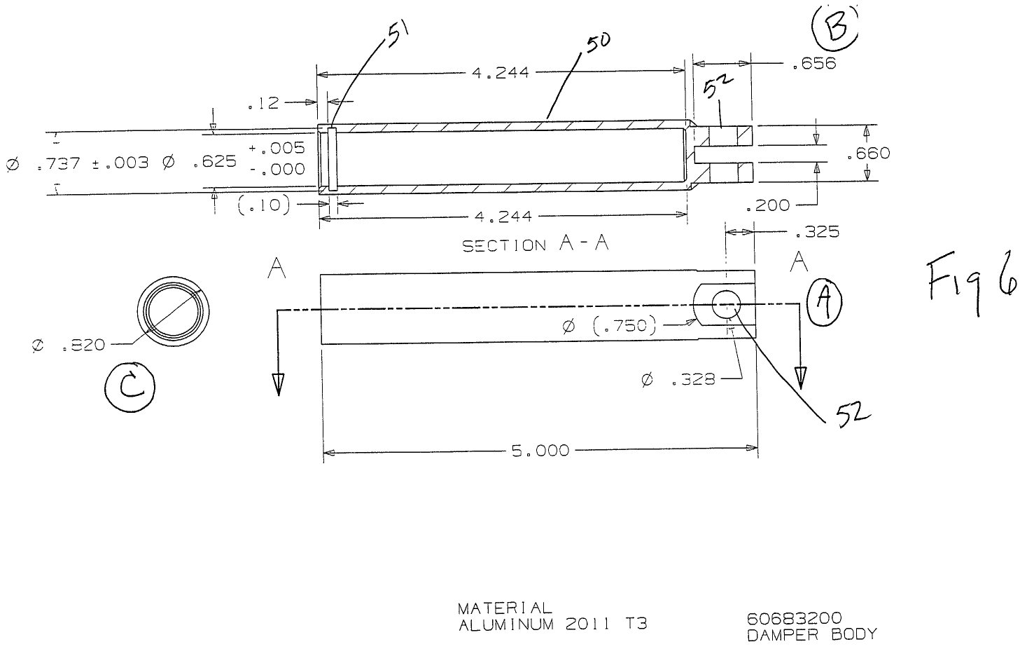

FIGS. 6-8 illustrate another aspect of the invention wherein the cylinder defines an internal groove for retaining an O-ring and the rod defines exterior grooves for controlling the rate of air passage within the dampening system. The connection point selection for the rod and cylinder are determined as described above in connection with FIGS. 3-5.

FIGS. 6A through 6C illustrate a cylinder 50 component of a dampening system wherein the a channel is defined on the interior 51 near the open end of cylinder 50. The end of the cylinder distal from open end defines an opening for receiving a fastener in order to connect the cylinder to the parking brake system.

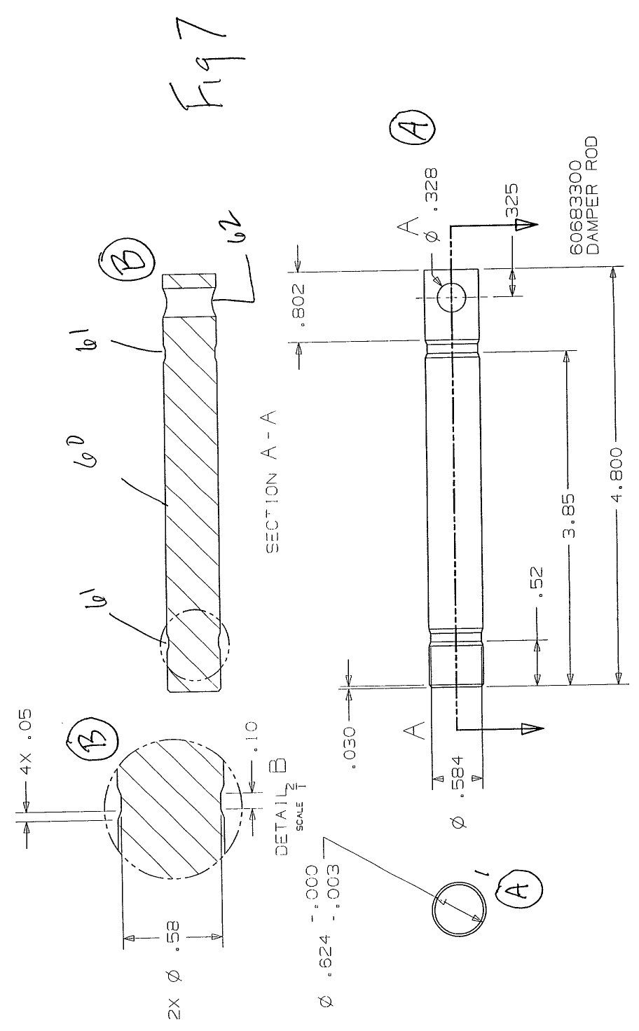

FIGS. 7A through 7B′ illustrate a piston or rod 60 that is dimensioned to be received within a cylinder (e.g, the cylinder of FIG. 6). Piston 60 defines depressed regions, chamfers or channels 61 that affect the rate at which air passes along piston 60 as it travels within a cylinder. Piston 60 also defines an opening 62 for receiving a fastener for connecting the piston to the parking brake system.

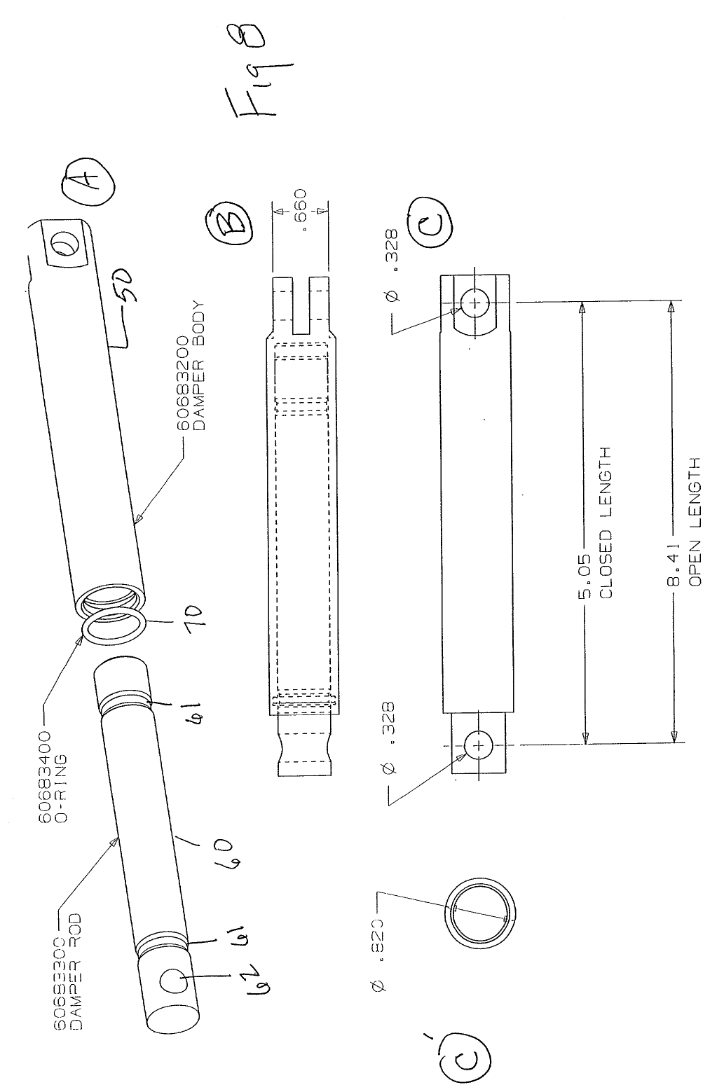

FIGS. 8A through C′ illustrate a dampening system combining the piston of FIG. 7 and cylinder of FIG. 6. FIG. 8 illustrates oil ring 70 adjacent to the channel or groove 51 defined in cylinder 50.

While this description emphasizes using the dampening system on a parking brake system, the inventive dampening system can be employed for virtually any application wherein it is desirable to have controlled release or application of mechanical energy or force. Non-limiting examples of such applications comprise shock absorbers, door opening devices, hinge supports, among other applications.

The following is claimed:

1). A parking brake system comprising a parking brake lever, a dampening system, at least one cable and a parking brake.

2). A controlled release parking brake system comprising a hand operated parking brake lever, a dampening system, at least one cable and a parking brake.

3). The parking brake system of claim 1 wherein the dampening system comprises a pneumatic apparatus.

4). The controlled release parking brake system of claim 1 wherein the dampening system comprises a hydraulic apparatus.

5). The parking brake system of claim 1 wherein the parking brake lever is pivotally mounted about a support member.

6). The parking brake system of claim 5 wherein one end of the dampening system comprises a first end that is connected to the parking brake lever and a second end that is connected to the member.

7). The parking brake system of claim 5 wherein the support member comprises a bracket.

8) The parking brake system of claim 1 wherein the dampening system comprises a rod and a cylinder.

9) The parking brake system of claim 8 wherein the cylinder is pivotally connected to the parking brake lever.

10). The parking brake system of claim 1 wherein the parking brake lever includes a release system that permits the parking brake system to be disengaged.

11). The parking brake system of claim 5 wherein the support member defines a slot that permits displacement of the dampening system.

12). The parking brake system of claim 3 wherein the pneumatic apparatus comprises a cylinder and piston wherein the piston is in fluid contact with the atmosphere surrounding the parking brake system.

13). The parking brake system of claim 12 wherein the piston defines at least one channel for affecting fluid flow through the dampening system.

14). The parking brake system of claim 12 wherein the cylinder defines a channel for receiving an O-ring that contacts the piston.
